(19) United States
(12) Patent Application Publication
(10) Pub. No.: US 2009/0270782 A1
(43) Pub. Date: Oct. 29, 2009

(54) Chair-type massage machine

(75) Inventors: Keisuke Shimizu, Suita (JP); Daisuke Morikawa, Kyoto (JP)

Correspondence Address: BACON & THOMAS, PLLC, 625 SLATERS LANE, FOURTH FLOOR, ALEXANDRIA, VA, 22314-1176, US

(73) Assignee: Panasonic Electric Works Co., Ltd., Osaka (JP)

(21) Appl. No.: 12/385,478

(22) Filed: Apr. 9, 2009

(30) Foreign Application Priority Data
Apr. 24, 2008 (JP) 2008-113543

(51) Int. Cl. A61H 7/00

(52) U.S. Cl. 601/148

(57) ABSTRACT

A chair-type massage machine includes a seat portion on which a user can sit, a backrest arranged at the rear of the seat portion so that the backrest can be tilted by a reclining mechanism, a footrest arranged at the front of the seat portion so that the footrest can be swung upwards and downwards by a swinging mechanism, and a control unit for inflating and deflating a waist airbag provided in the backrest toward and away from the waist of the user. The control unit is configured to control the inflation of the waist airbag in conjunction with the upward swinging movement of the footrest to perform a waist curving operation on the user.

### FIELD OF THE INVENTION

The present invention relates to a chair-type massage machine preferably used in curving the waist of a user.

### BACKGROUND OF THE INVENTION

Conventionally, there is well-known a chair-type massage machine including a plurality of airbags provided in a backrest or a seat portion as disclosed in, e.g., Japanese Patent Laid-open Publication No. H-9-122193. The chair-type massage machine is designed to give a stretching effect to a user by extending the user's body through inflation and deflation of the airbags.

When curving primarily the user's waist with the chair-type massage machine cited above, the airbag provided at the lower end of the backrest is inflated so as to curve the user's waist.

Since the airbag has a limited capacity, no great enough curving sense is obtained by merely inflating the airbag upon the waist curving operation. Therefore, a demand has existed for improvement of the chair-type massage machine.

### SUMMARY OF THE INVENTION

In view of the above, the present invention provides a chair-type massage machine capable of performing a waist curving operation in a desirable manner so as to give an enhanced waist curving sense to a user.

In accordance with an aspect of the present invention, there is provided a chair-type massage machine including:

a seat portion on which a user can sit;

a backrest arranged at the rear of the seat portion so that the backrest can be tilted by a reclining mechanism, the backrest provided with a waist airbag;

a footrest arranged at the front of the seat portion so that the footrest can be swung upwards and downwards by a swinging mechanism; and

a control unit for inflating and deflating the waist airbag toward and away from the waist of the user, wherein the control unit is configured to control the inflation of the waist airbag in conjunction with the upward swinging movement of the footrest to perform a waist curving operation on the user.

With the present invention, the inflation of the waist airbag is controlled in conjunction with the upward swinging movement of the footrest by the control unit, thereby performing the waist curving operation on the user. In this case, the control operation is executed so as to, e.g., inflate the waist airbag after the backrest has been tilted into a reclined state, to tilt the backrest into the reclined state after the waist airbag has been inflated, or to simultaneously perform the inflation of the waist airbag and the operation of tilting the backrest into the reclined state. Therefore, as the footrest is swung upwards, the feet (or legs) of the user are lifted up so that the weight of the user is partially applied to the backrest. As a result, the waist of the user is firmly pressed against the waist airbag and the inflation of the waist airbag gives an enhanced waist curving sense to the user. This makes it possible to perform the waist curving operation in a desirable manner.

The control unit may be configured to simultaneously cause the deflation of the waist airbag and the downward swinging movement of the footrest when releasing the waist curving operation.

With the present invention, the deflation of the waist airbag and the downward swinging movement of the footrest when releasing the waist curving operation are controlled by the control unit so as to be performed simultaneously. In other words, the waist curving state in which the feet (or legs) of the user are lifted up can be restored to the original state within a short period of time.

Further, the control unit may be configured to bring the backrest into a reclined state in conjunction with at least one of the inflation of the waist airbag and the upward swinging movement of the footrest.

With the present invention, the control operation is executed to ensure that the backrest is brought into a reclined state in conjunction with at least one of the inflation of the waist airbag and the upward swinging movement of the footrest. Since the back of the user is nearly in a lying-down state, the weight of the user is partially applied to the backrest and the waist is firmly pressed against the waist airbag. This further enhances the waist curving sense, thereby making it possible to perform the waist curving operation in a desirable manner.

In accordance with another aspect of the present invention, there is provided a chair-type massage machine including:

a seat portion on which a user can sit;

a backrest arranged at the rear of the seat portion so that the backrest can be tilted by a reclining mechanism, the backrest provided with a waist airbag; and

a control unit for inflating and deflating the waist airbag toward and away from the waist of the user,

wherein the control unit is configured to control the inflation of the waist airbag in conjunction with the tilting operation of the backrest to perform a waist curving operation on the user.

With the present invention, the inflation of the waist airbag is controlled in conjunction with the operation of tilting the backrest into a reclined state by the control unit, thereby performing the waist curving operation on the user. In this case, the control operation is executed so as to, e.g., inflate the waist airbag after the backrest has been tilted into a reclined state, to tilt the backrest into the reclined state after the waist airbag has been inflated, or to simultaneously perform the inflation of the waist airbag and the operation of tilting the backrest into the reclined state. Since the back of the user is nearly in a lying-down state, the weight of the user is partially applied to the backrest and the waist is firmly pressed against the waist airbag. As a result, the inflation of the waist airbag gives an enhanced waist curving sense to the user. This makes it possible to perform the waist curving operation in a desirable manner.

In accordance with the present invention, it is possible to provide a chair-type massage machine capable of performing a waist curving operation in a desirable manner so as to give an enhanced waist curving sense to a user.

### BRIEF DESCRIPTION OF THE DRAWINGS

The objects and features of the present invention will become apparent from the following description of embodiments, given in conjunction with the accompanying drawings, in which:

FIG. 1 is a schematic configuration view showing a chair-type massage machine in accordance with one embodiment of the present invention;

FIG. 2 is a schematic view showing a front image of the chair-type massage machine;

FIG. 3 is a control block diagram of the chair-type massage machine;

FIG. 4 is an explanatory view for explaining the operation of the chair-type massage machine; and

FIG. 5 is a timing chart for explaining an example of the operation of the chair-type massage machine.

### DETAILED DESCRIPTION OF THE PREFERRED EMBODIMENTS

Hereinafter, one embodiment of the present invention will be described with reference to the accompanying drawings which form a part hereof.

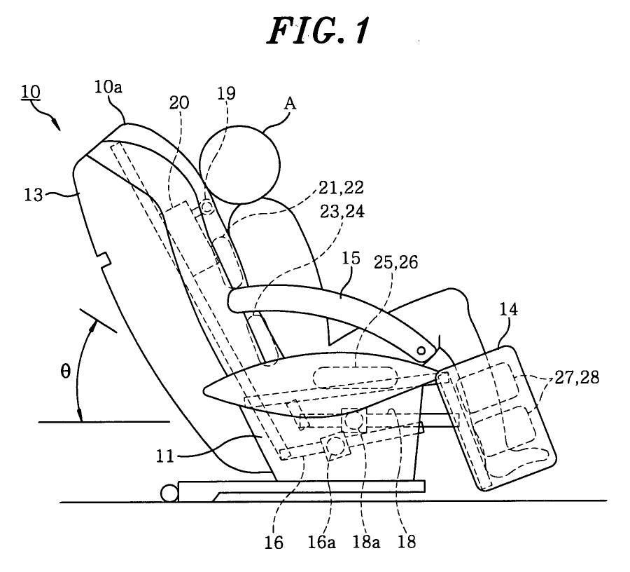

Referring to FIGS. 1 to 3, a chair-type massage machine 10 of the present embodiment includes a main body 10a having a pair of left and right support legs 11, a seat portion 12 supported by the support legs 11 and a backrest 13 attached to the rear end of the seat portion 12 for tilting movement about a transverse rotation axis. The chair-type massage machine includes a footrest 14 attached to the front end of the seat portion 12 for tilting movement about a transverse rotation axis and armrests 15 attached to the opposite sides of the seat portion 12 to extend in the back-and-forth direction.

A mechanism 16 for reclining the backrest 13 is provided on the lower side of the seat portion 12. A controller 17 is provided to control the operation of a motor 16a of the reclining mechanism 16 so that the backrest 13 can be reclined. A mechanism 18 for swinging the footrest 14 upwards and downwards is provided on the lower side of the seat portion 12. The controller 17 also controls the operation of a motor 18a of the swinging mechanism 18 so that the footrest 14 can be swung upwards and downwards.

The footrest 14 includes substantially “U”-shaped accommodation recesses 14a for accommodating the left and right legs of a user A and bottom portions 14b provided at the lower ends of the accommodation recesses 14a for making contact with the soles of the user's feet and supporting the feet and legs of the user A from below.

A massage mechanism 20 having massage treatment members 19 is arranged in the transverse center portion of the backrest 13. The massage mechanism 20 is movable upwards and downwards along the backrest 13 by means of a motor (not shown). Also built in the massage mechanism 20 is a motor (not shown) for causing the massage treatment members 19 to perform their treatment operation. The massage mechanism 20 performs massage treatments on the back of the user A using the massage treatment operation of the massage treatment members 19 caused by the various kinds of motors.

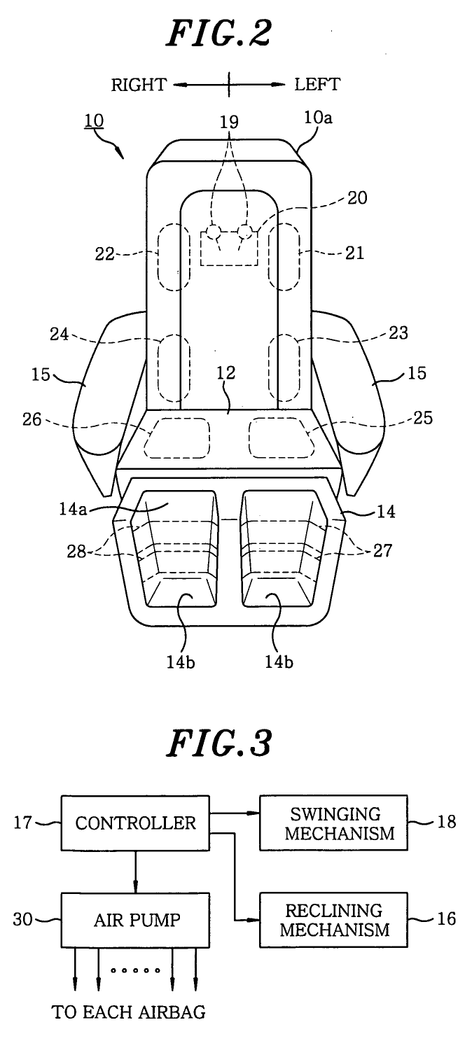

As shown in FIG. 2, a pair of left and right shoulder airbags 21 and 22 is embedded in the upper left and right areas of the backrest 13 in a corresponding relationship with the left and right shoulders of the user A. A pair of left and right waist airbags 23 and 24 is embedded in the lower left and right areas of the backrest 13 in a corresponding relationship with the left and right waist portions of the user A. A pair of left and right hip airbags 25 and 26 is embedded in the left and right areas of the seat portion 12 in a corresponding relationship with the left and right hips of the user A. Leg airbags 27 and 28 are embedded in the inner walls of the left and right accommodation recesses 14a of the footrest 14. The respective airbags 21 to 28 corresponding to individual target treatment portions are connected, through connection hoses (not shown), to an air pump 30 installed between the support legs 11 below the seat portion 12. The operation of the air pump 30 is controlled by the controller 17 as a control unit so as to inflate and deflate the respective airbags 21 to 28.

In the chair-type massage machine 10 configured as above, the controller 17 suitably controls the respective parts to perform massage treatments or stretching on the body portions of the user A. In particular, the waist can be curved by operating the waist airbags 23 and 24 and the footrest 14 together.

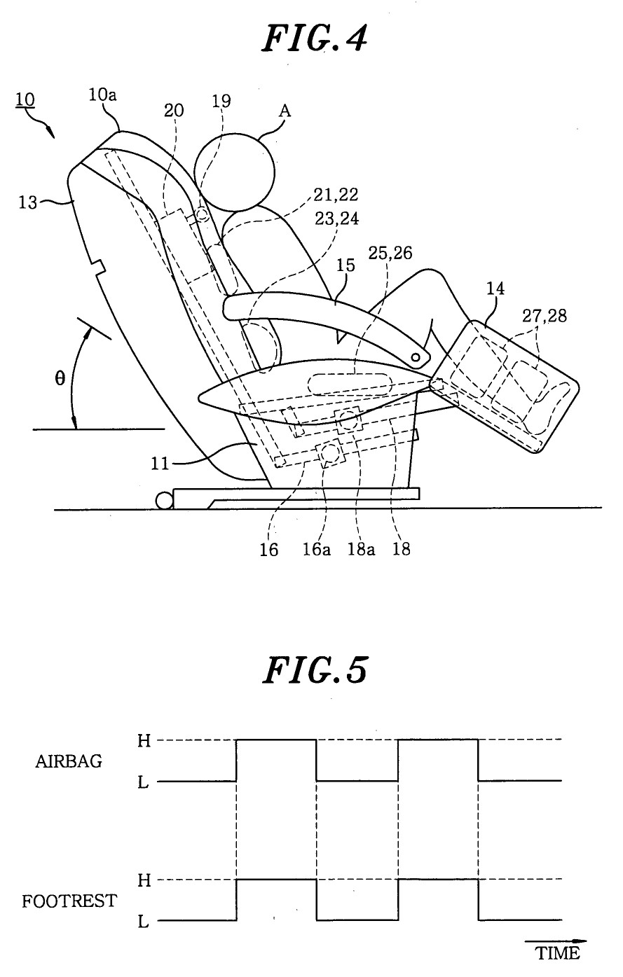

More specifically, the controller 17 outputs a high level signal H (see FIG. 5) to the air pump 30 (an electromagnetic valve thereof) to inflate the waist airbags 23 and 24, thereby bringing the waist airbags 23 and 24 from a collapsed state (see FIG. 1) into an expanded state (see FIG. 4). Simultaneously, the controller 17 outputs a high level signal H (see FIG. 5) to the motor 18a of the swinging mechanism 18 to have the footrest 14 swung upwards, thus bringing the footrest 14 from a low position sate (see FIG. 1) into a high position state (see FIG. 4). As the footrest 14 is swung upwards, the feet (or legs) of the user A is lifted up so that the weight of the user A is partially applied to the backrest 13. As the waist airbags 23 and 24 are inflated, the waist of the user A is lifted up and curved. Thus the waist is pressed against the waist airbags 23 and 24 by a force greater than available when the waist is curved by the operation of the waist airbags 23 and 24 alone. This enhances the waist curving sense.

After the waist airbags 23 and 24 are brought into the expanded state with the footrest 14 into the high position state, the controller 17 outputs a low level signal L (see FIG. 5) to the air pump 30 (the electromagnetic valve thereof) to deflate the waist airbags 23 and 24, thereby bringing the waist airbags 23 and 24 from the expanded state into the collapsed state. Simultaneously, the controller 17 outputs a low level signal L (see FIG. 5) to the motor 18a of the swinging mechanism 18 to have the footrest 14 swung downwards, thus bringing the footrest 14 from the high position sate into the low position state.

The controller 17 is configured to give a stretching effect to the user A by, e.g., repeatedly causing joint movement of the waist airbags 23 and 24 and the footrest 14 and repeatedly performing the waist curving operation by which to give an enhanced waist curving sense to the user A.

Next, description will be made on the characterizing operational effects of the present embodiment.

(1) The inflation of the waist airbags 23 and 24 and the upward swinging movement of the footrest 14 are jointly controlled by the controller 17 to curve the waist of the user A. In this case, the inflation of the waist airbags 23 and 24 and the upward swinging movement of the footrest 14 are performed simultaneously. Therefore, as the footrest 14 is swung upwards, the feet (or legs) of the user A is lifted up so that the weight of the user A is partially applied to the backrest 13. As a result, Since the waist of the user A is firmly pressed against the waist airbags 23 and 24, the inflation of the waist airbags 23 and 24 gives an enhanced waist curving sense to the user A. This makes it possible to perform the waist curving operation in a desirable manner.

(2) When releasing the waist curving operation, the deflation of the waist airbags 23 and 24 and the downward swinging movement of the footrest 14 are controlled by the controller 17 so as to be performed simultaneously. In other words, the waist curving state in which the feet (or legs) of the user A is lifted up can be restored to the original state within a short period of time.

The embodiment of the present invention may be modified as follows.

Although the inflation of the waist airbags 23 and 24 and the upward swinging movement of the footrest 14 are performed simultaneously in the above-described embodiment, the present invention is not limited thereto. Alternatively, the upward swinging movement of the footrest 14 may be performed after the inflation of the waist airbags 23 and 24. As a further alternative, the inflation of the waist airbags 23 and 24 may be performed after the upward swinging movement of the footrest 14. With this configuration, it is possible to obtain the same effects as available in the above-described embodiment.

Although the feet (or legs) of the user A are lifted up using the bottom portions 14b of the footrest 14 in the above-described embodiment, the present invention is not limited thereto. As an alternative example, the legs may be lifted up by inflating the leg airbags 27 and 28 provided in the footrest 14 to grip the legs therebetween.

Although not specifically mentioned in above-described embodiment, a tilting operation by which the backrest 13 is tilted at a specified angle e (e.g., 30 degrees) and brought into a reclined state may be performed in conjunction with the inflation of the waist airbags 23 and 24 and the upward swinging movement of the footrest 14. With this configuration, the back of the user A is nearly in a lying-down state. Therefore, the weight of the user A is partially applied to the backrest 13 and the waist is firmly pressed against the waist airbags 23 and 24. This further enhances the waist curving sense, thereby making it possible to perform the waist curving operation in a desirable manner.

It may also be possible to employ a configuration in which the inflation of the waist airbags 23 and 24 is performed together with the tilting operation of the backrest 13 while omitting the concurrent movement of the footrest 14. Examples of the control method for performing the inflation of the waist airbags 23 and 24 in conjunction with the tilting operation of the backrest 13 include inflating the waist airbags 23 and 24 after the backrest 13 has been tilted into a reclined state, tilting the backrest 13 into the reclined state after the waist airbags 23 and 24 have been inflated and simultaneously performing the inflation of the waist airbags 23 and 24 and the operation of tilting the backrest 13 into the reclined state. With this configuration, the back of the user A is nearly in a lying-down state. Therefore, the weight of the user A is partially applied to the backrest 13 and the waist is firmly pressed against the waist airbags 23 and 24. As a result, the inflation of the waist airbags 23 and 24 enhances the waist curving sense felt by the user A, thereby making it possible to perform the waist curving operation in a desirable manner.

Although the massage mechanism 20 is provided in the above-described embodiment, it may be possible to eliminate the massage mechanism 20.

While the invention has been shown and described with respect to the embodiments, it will be understood by those skilled in the art that various changes and modification may be made without departing from the scope of the invention as defined in the following claims.

What is claimed is:

1. A chair-type massage machine comprising:
a seat portion on which a user can sit;
a backrest arranged at the rear of the seat portion so that the backrest can be tilted by a reclining mechanism, the backrest provided with a waist airbag;
a footrest arranged at the front of the seat portion so that the footrest can be swung upwards and downwards by a swinging mechanism; and
a control unit for inflating and deflating the waist airbag toward and away from the waist of the user,
wherein the control unit is configured to control the inflation of the waist airbag in conjunction with the upward swinging movement of the footrest to perform a waist curving operation on the user.

2. The chair-type massage machine of claim 1, wherein the control unit is configured to simultaneously cause the deflation of the waist airbag and the downward swinging movement of the footrest when releasing the waist curving operation.

3. The chair-type massage machine of claim 1, wherein the control unit is configured to bring the backrest into a reclined state in conjunction with at least one of the inflation of the waist airbag and the upward swinging movement of the footrest.

4. The chair-type massage machine of claim 2, wherein the control unit is configured to bring the backrest into a reclined state in conjunction with at least one of the inflation of the waist airbag and the upward swinging movement of the footrest.

5. A chair-type massage machine comprising:
a seat portion on which a user can sit;
a backrest arranged at the rear of the seat portion so that the backrest can be tilted by a reclining mechanism, the backrest provided with a waist airbag; and
a control unit for inflating and deflating the waist airbag toward and away from the waist of the user,
wherein the control unit is configured to control the inflation of the waist airbag in conjunction with the tilting operation of the backrest to perform a waist curving operation on the user.
